(19) United States
(12) Patent Application Publication
(10) Pub. No.: US 2018/0225905 A1
(43) Pub. Date: Aug. 9, 2018

(54) COGNITIVE PLANNING TO CONSERVE RESOURCES

(71) Applicant: International Business Machines Corporation, Armonk, NY (US)

(72) Inventors: Shang Qing Guo, Cortlandt Manor, NY (US); Jonathan Lenchner, North Salem, NY (US); Maharaj Mukherjee, Poughkeepsie, NY (US)

(21) Appl. No.: 15/427,294

(22) Filed: Feb. 8, 2017

(51) Int. Cl. G07F 9/00; G06Q 10/06

(52) U.S. Cl. CPC G07F 9/006; G06Q 10/06315

(57) ABSTRACT

Techniques facilitating cognitive planning to conserve resources are provided. In one example, a computer-implemented method can comprise determining, by a system operatively coupled to a processor, a first parameter associated with withdrawal of one or more units from a first unit dispensing device. The withdrawal of one or more units can be based on an expected unit requirement determined based on a defined interval and data related to a first entity associated with a computing device that requested a search for one or more unit dispensing devices within a defined geographic area. The computer-implemented method can also include generating, by the system, a location identification of the first unit dispensing device based on a determination that the first parameter is less than a second parameter associated with respective withdrawals of one or more units from a second unit dispensing device within the defined geographic area.

### BACKGROUND

The subject disclosure relates to planning, and more specifically, cognitive planning to conserve resources.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, computer-implemented methods, apparatus and/or computer program products that facilitate cognitive route planning for unit replenishment are described.

According to an embodiment, a computer-implemented method can comprise determining, by a system operatively coupled to a processor, a first parameter associated with withdrawal of one or more units from a first unit dispensing device. The withdrawal of one or more units can be based on an expected unit requirement determined based on a defined interval and data related to a first identity of a first entity associated with a computing device that requested a search for one or more unit dispensing devices within a defined geographic area. The computer-implemented method can also include generating, by the system, a location identification of the first unit dispensing device based on a determination that the first parameter is less than a second parameter associated with respective withdrawals of one or more units from a second unit dispensing device within the defined geographic area.

According to an embodiment, a system can comprise a memory that stores computer executable components and a processor that executes computer executable components stored in the memory. The computer executable components can comprise a parameter analysis component that determines a first parameter associated with a first withdrawal of one or more units from a first unit dispensing device based on an expected unit requirement over a first defined interval and data related to a first entity. The computer executable components can also comprise an interface component that facilitates a first output of a location identification of the first unit dispensing device at a computing device associated with the first entity based on the first parameter being less than a second parameter associated with a second withdrawal of one or more units from a second unit dispensing device based on the expected unit requirement over the first defined interval and the data related to the first entity.

According to another embodiment, a computer program product for facilitating cognitive planning to conserve resources can comprise a computer readable storage medium having program instructions embodied therewith. The program instructions are executable by a processing component. The program instructions can cause the processing component to determine, by the processing component, a first parameter associated with a first withdrawal of units from a first unit dispensing device is less than a second parameter associated with a second withdrawal of units from a second unit dispensing device. The program instructions can also cause the processing component to facilitate, by the processing component, an output of a location identification of the first unit dispensing device at a computing device associated with a first identity of a first entity that requested a search for one or more unit dispensing devices within a defined geographic area. The first withdrawal of units and the second withdrawal of units can comprise a quantity of units based on an expected unit requirement for the first entity during a defined interval.

### DESCRIPTION OF THE DRAWINGS

FIG. 1 illustrates a block diagram of an example, non-limiting system that facilitates cognitive planning in accordance with one or more embodiments described herein.

FIG. 2 illustrates a block diagram of an example, non-limiting system that facilitates cognitive planning while conserving resources in accordance with one or more embodiments described herein.

FIG. 3 illustrates an example, non-limiting chart that displays time on a different axis than an expense associated with the withdrawal of units from one or more unit dispensing devices in accordance with one or more embodiments described herein.

FIG. 4 illustrates a block diagram of an example, non-limiting system that utilizes machine learning to enhance the cognitive planning in accordance with one or more embodiments described herein.

FIG. 5 illustrates a flow diagram of an example, non-limiting computer-implemented method that facilitates cognitive planning in accordance with one or more embodiments described herein.

FIG. 6 illustrates a flow diagram of an example, non-limiting computer-implemented method that facilitates cognitive planning in accordance with one or more embodiments described herein.

FIG. 7 illustrates a flow diagram of an example, non-limiting computer-implemented method that adjusts unit withdrawal recommendations based on actual consumption of the units in accordance with one or more embodiments described herein.

FIG. 8 illustrates a block diagram of an example, non-limiting operating environment in which one or more embodiments described herein can be facilitated.

FIG. 9 depicts a cloud computing environment in accordance with one or more embodiments described herein.

FIG. 10 depicts abstraction model layers in accordance with one or more embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

In various locations with a geographic area, unit dispensing devices can be placed to allow withdrawal of units by entities within the geographic area. The unit dispensing devices can be stocked with units and, when an entity desires to withdrawal units, the entity can travel to the unit dispensing device and can obtain the desired amount of units. In some cases, there can be a fee charged for the dispensing of units from the unit dispensing devices. Thus, it can be beneficial to withdraw a quantity of units that mitigates the need to make repeated trips to withdraw units, while concurrently not withdrawing a quantity of units that is too many for a given interval. The various aspects discussed herein attempt to reduce fees involved with dispensing units while suggesting an optimal quantity of units to withdraw.

In a specific example, a unit dispensing device can be an Automated Teller Machine (ATM) and the units being withdrawn can be cash. Individuals, at times, might not be certain as to how much cash they should withdraw at a particular time. Sometimes, the quantity needed is underestimated and a withdrawal is made for less money than what is needed over the course of a time period, requiring the individual to make one or more additional trips to ATMs and potentially could need to pay ATM fees for the additional ATM withdrawals. At other times, the quantity to withdraw is overestimated and, therefore, more cash is withdrawn than what is needed for a given time period. This can result in an additional fee in the case where an ATM charges a fee in proportion to an amount withdrawn and/or lost interest on the cash. Further, having too much cash on hand can create a security risk due to the potential of a taking or the cash could be misplaced or lost. The various aspects provided herein can determine the amount of cash that should be withdrawn for a given time period. Further, the various aspects can direct the individual to a nearest ATM, or another ATM selected based on defined parameters, that would charge a minimum fee or has a lowest cost associated with withdrawal of the determined amount of cash.

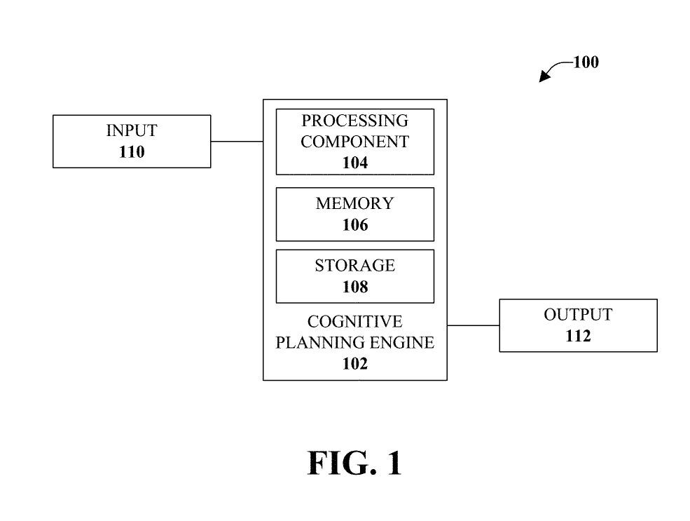

FIG. 1 illustrates a block diagram of an example, non-limiting system 100 that facilitates cognitive planning in accordance with one or more embodiments described herein. Aspects of systems (e.g., non-limiting system 100 and the like), apparatuses, or processes explained in this disclosure can constitute machine-executable component(s) embodied within machine(s), e.g., embodied in one or more computer readable mediums (or media) associated with one or more machines. Such component(s), when executed by the one or more machines, e.g., computer(s), computing device(s), virtual machine(s), etc. can cause the machine(s) to perform the operations described.

In various embodiments, non-limiting system 100 can be any type of component, machine, device, facility, apparatus, and/or instrument that comprises a processor and/or can be capable of effective and/or operative communication with a wired and/or wireless network. Components, machines, apparatuses, devices, facilities, and/or instrumentalities that can comprise non-limiting system 100 can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, and the like.

As illustrated, non-limiting system 100 can comprise a cognitive planning engine 102, a processing component 104, a memory 106, and/or a storage 108. In some embodiments, one or more of the cognitive planning engine 102, the processing component 104, the memory 106, and/or the storage 108 can be communicatively and/or operatively coupled to one another to perform one or more functions of the non-limiting system 100.

The cognitive planning engine 102 can recommend a unit dispensing device from which to withdrawal units based on an indication from an entity that unit withdrawal is desired. Further, the cognitive planning engine 102 can provide data related to a route to traverse to the unit dispensing device. Additionally, the cognitive planning engine 102 can recommend a quantity of units to withdraw from the unit dispensing device.

In order to provide the recommendations, the cognitive planning engine 102 can receive one or more inputs 110. In various embodiments, the cognitive planning engine 102 can receive as the one or more inputs 110 data related to one or more entities that can withdraw units from unit dispensing devices, data related to computing devices associated with respective ones of the one or more entities, data related to a time interval under consideration for which the units are desired, data related to one or more unit dispensing devices, and/or data related to influences external to the one or more entities and the one or more dispensing devices. As utilized herein an “entity” can be one or more computers, the Internet, one or more systems, one or more commercial enterprises, one or more computers, one or more machines, machinery, one or more actors, one or more users, one or ore more customers, one or more humans, and so forth, hereinafter referred to as an “entity” or “entities,” depending on the context.

The input data related to the one or more entities can include identification data indicative of a user of a computing device and historical unit withdrawal patterns. For example, withdrawals of an entity can be monitored over time (e.g., days, weeks, and so on) and withdrawal patterns can be determined. The withdrawal patterns can indicate a quantity of units that have historically been consumed by an entity over various periods of time. In another example, the withdrawal patterns can indicate a quantity of units that have historically been consumed by the entity based on other parameters, such as activities in which the entity engages, presence of one or more other entities, mood of the entity, social behavior of the entity, and so on.

In an example related to mood and money, spending habits can change depending on an individual's mood. The cognitive planning engine 102 can learn from previous behavior and can take such behavior into account when determining the expected unit requirement. In another example related to weather and money, weather can influence spending habits, which the cognitive planning engine 102 can recognize and can correct the expected unit requirement based on this recognition. For example, inclement weather could influence an individual to obtain certain emergency supplies and keep cash at home for emergencies. Bad weather can force individuals to stay at home and spend less. Further, weather can influence mood. In another example related to social behavior and money, individuals might tend to spend differently depending on their company. The cognitive planning engine 102 can learn based on an electronic calendar and social engagements (e.g., visiting a store or a mall with a friend) whether other individuals will be around and can adjust the expected unit requirement accordingly.

The input data related to computing devices associated with respective ones of the one or more entities can include location data, when can be determined upon or after an intent to withdrawal units is received. The intent can be determined based on the requestor initiating a search for one or more dispensing devices through an associated computing device. The search for the one or more dispensing devices can be within a defined geographic area that can be determined based on a location of the computing device (e.g., the location of the requestor using the computing device). Alternatively, the requestor can provide a desired location (e.g., zip code, a “located near” search) for the search. This can be useful if the requestor is in a first location when the request was received and plans to be in a second location when the units are withdrawn.

Additionally, the input data related to computing devices associated with respective ones of the one or more entities can include data indicative of planned and/or upcoming events and/or the other entities that are also planning to attend the event(s). In one example, the computing device(s) can provide information related to a social network to which the entity belongs. The device(s) can also provide location information through a Global Positioning System (GPS) or another location technique. Further, the computing device can provide information about a mode of travel being used by the entity (e.g., walking, running, riding a bicycle, on a motorbike, in a vehicle). Such information can be determined based on a route the entity is traversing as well as a travel speed. For example, if the entity is on a path in a park, where vehicles are not allowed, it can be inferred that the entity is walking or riding a bike, which can be further determined based on a speed (e.g., a bicycle should be faster than walking or running).

Additionally, the input data related to the one or more entities can include a defined time period for the unit withdrawal during which the requestor plans to consume the units. The input data related to the time interval under consideration can include a defined period of time (e.g., for the next week, for the next eleven days). The time interval data can be specified by the entity, such as through an electronic input from the entity, which can be received with the indication that unit withdrawal is desired. In another example, the time interval can be inferred based on historical information of the entity. For example, if the entity historically withdraws units every nine to thirteen days, the input can include a pattern, if any, related to the nine to thirteen days. For example, if the withdrawal is quicker (e.g., at nine days) when the entity attends an event and is slower (e.g., after thirteen days) when the entity does not attend the event, and an event is planned during a defined interval, it can be inferred that additional units might be useful during the defined interval.

The input data related to the one or more unit dispensing devices can include an indication of fees charged, if any, for a withdrawal of units. For example, the non-limiting system 100 can be operatively coupled to the one or more dispensing units, or to respective devices that can be in communication with the one or more dispensing units. In an example, security concerns associated with the unit dispensing devices could be in place and, therefore, instead of the non-limiting system 100 being in direct communication with the unit dispensing devices, a device trusted by an entity responsible for the unit dispensing devices can be in electronic communication with the non-limiting system 100 over an electronic communications network.

Additionally, the input data related to the one or more unit dispensing devices can include respective locations of the unit dispensing devices. Since unit dispensing devices can be located within a geographic area and generally do not move locations, the location data can be static data that can be updated on an as needed basis (e.g., when a unit dispensing device is moved, removed, or added to a geographic area).

The input data related to influences external to the one or more entities and the one or more dispensing device can include information related to an environment of the one or more entities and/or the one or more dispensing devices. Such data can include environmental conditions, such as current weather conditions and/or expected weather conditions. For example, a current weather condition at a unit dispensing device could make it difficult to travel to the unit dispensing device. According to some implementations, external influences can be unforeseen events, such as traffic accidents or medical issues. Other examples of external influences can be road traffic conditions, including road closures, detours, traffic congestion, and large gatherings of individuals.

In accordance with an embodiment, the cognitive planning engine 102 upon or after receiving the inputs 110 can generate one or more recommendations related to a quantity of units to withdraw and/or a location of a unit dispensing device from which to withdraw the units. The recommendation can be provided as output 112 from the cognitive planning engine 102.

In an example, the unit dispensing devices can be cash withdrawal stations or automated teller machines. The unit dispensing devices can be placed in various locations within a city for convenient withdrawal of units from the unit dispensing devices. For example, the unit dispensing devices can be located adjacent to a financial entity, can be located in a grocery store, can be located in a shopping mall, or in other locations. It is noted that although various aspects are discussed herein with respect to automated teller machines and cash disbursement from the automated teller machines, the disclosed aspects are not limited to this implementation. Instead, the various aspects can be utilized for a variety of items or products for which disbursement of the item and/or product can be part of an on-demand process including, but not limited to, monetary units, such as cash, and non-monetary units, such as products, pharmaceutical items, groceries, gasoline or fuel, and commodities.

For ATMs, the cognitive planning engine 102 can predict a needed amount of cash based on the defined time period during which the requestor needs cash and can determine an ATM from which to withdraw the cash while conserving resources. For example, one or more predicted amounts of cash, an ATM recommended for withdrawal of the cash, and selected ATM information can be displayed on a computing device associated with the requestor, or output through speakers of the computing device.

The cognitive planning engine 102 can compare predicted cash needs based on the requestor's cash spending activity (e.g., purchase history information) with actual cash spending information and adapt future predictions based on the comparison. Additionally or alternatively, the cognitive planning engine 102 can modify predicted cash needs based one or more of: calendar information, e-mail information, weather information, behavioral information, and social network information (e.g., electronic social feeds). In some implementations, receiving input data can include retrieving information regarding cash purchase history information, which can be retrieved from a data store or memory. Modifying the predicted cash needs can be based on a combination of the information, such as cleaning expenses in combination with weather information (e.g., if it is snowing or raining, expenses for cleaning clothing could increase during the defined time period). The information can include possible cash needs associated with an event identified as occurring during the time period, based on information obtained from one or more of email information, calendar information and/or social network information. Further to this implementation, the cognitive planning engine 102 can classify the requestor with a cohort (e.g., another entity, such as a friend, co-worker, or family member) and the prediction can be based on spending data associated with the event and the cohort.

Based on the initial input data and the inferred data, the cognitive planning engine 102 can obtain a geo-location of the requestor and one or more unit dispensing devices within a defined distance to the geo-location. The cognitive planning engine 102 can also obtain and determine respective unit dispensing device information for the unit dispensing devices within the defined information. The respective unit dispensing device information can include fee information (e.g., a fee for withdrawal of cash as it applies to the requestor) and distance information (e.g., a traversable distance between the requestor and the unit dispensing device).

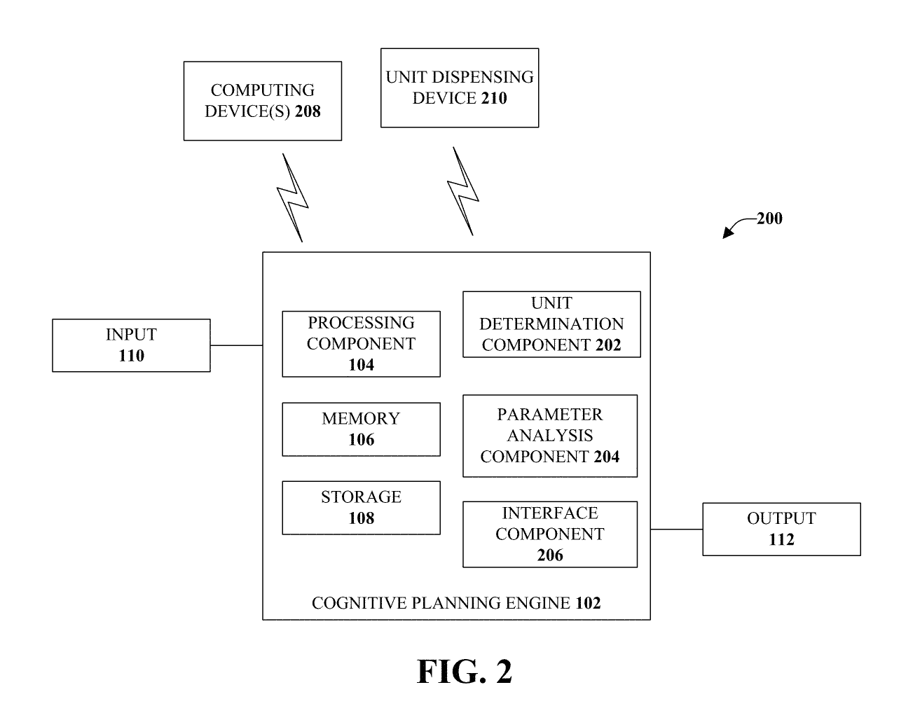

FIG. 2 illustrates a block diagram of an example, non-limiting system 200 that facilitates cognitive planning while conserving resources in accordance with one or more embodiments described herein. Repetitive description of like elements employed in other embodiments described herein is omitted for sake of brevity.

The non-limiting system 200 can comprise one or more of the components and/or functionality of non-limiting system 100, and vice versa. As illustrated, the cognitive planning engine 102 of non-limiting system 200 can comprise a unit determination component 202, a parameter analysis component 204, and an interface component 206.

The unit determination component 202 can determine a quantity of units expected to be used by the requesting entity over a defined time interval. For example, upon or after an intent or request to withdraw units is received from a requester (e.g., through respective computing devices), the unit determination component 202 can facilitate output of a prompt or other query at one or more computing devices 208 associated with the requestor(s). The prompt can include a request to define a time interval for the withdrawal of units, or can be a request for confirmation of a time interval inferred by the unit determination component 202. For example, the requestor can indicate the interval through, for example, the computing device 208 (e.g., a user can use her computing device), such as by the requestor interfacing with an electronic display screen or electronic microphone of the computing device 208.

The unit determination component 202 can determine the quantity of units recommended to be withdrawn based on historical information associated with the requestor. For example, the unit determination component 202 can review an electronic calendar stored in the computing device 208, as well as other regular activities for which the requestor historically has consumed units. For example, if the units are cash, the requestor might have historically consumed the cash to purchase coffee, a newspaper, pay for parking meter fees, do laundry, purchase groceries, and other products and/or services for which the requestor can use cash. In accordance with some implementations, the unit determination component 202 can determine, in the case of cash, denominations of the cash that should be withdrawn in addition to the amount. For example, if it is expected that the requestor will be incurring a large amount of parking meter fees during the defined time period, smaller denominations might be recommended (as it can be easier to obtain change for smaller denominations).

According to some implementations, the unit determination component 202 can evaluate unusual activities and/or infrequent activities. For example, the unit determination component 202 can evaluate the electronic purchase history stored in the computing device 208 for indications that additional units might be consumed during the defined time period. For example, the indication can be that the requestor has purchased tickets for an event, such as a fair, a ball game, an entertainment show, or another event. Based on the one or more unusual or infrequent events that are scheduled during the defined time period, the unit determination component 202 can determine that more units should be withdrawn for the defined time period. For example, if the requestor is attending a fair, the requestor might consume more cash in order to purchase food, drinks, ticket rides, or other incidentals associated with the fair.

Additionally or alternatively, the unit determination component 202 can facilitate output of a prompt or request on the computing device 208 (e.g., the requestor's computing device). The prompt can ask the requestor whether there are additional activities that the requestor plans to attend during the defined time period. Based on a response received from the requestor, the amount of units recommended for withdrawal can be adjusted accordingly. In some cases, the unit determination component 202 can request the additional information for events that were not discovered using the electronic calendar, electronic purchase history, or regular (historic) activity history.

For the one or more activities, the unit determination component 202 can determine the units that are expected to be consumed based on the requestor's previous consumption history. Further, the unit determination component 202 can adjust the unit requirement for the one or more activities based on other activities, weather, behavior, and social network. In a use case example, if the whether was rainy or the requestor had travelled during the previous week, it might be expected that the requestor might need additional laundry loads and, therefore, will need more cash for the laundry. In another use case example, if the requestor is hosting a party over the weekend (e.g., determined based on email and electronic social network communications), the requestor can use more cash for groceries and beverages, if the requestor has historically purchased groceries and beverages with cash. In another use case example, if the requestor is planning to go to a ball game with a certain person or group of people (e.g., family, friends, significant other), the requestor's spending pattern can change based on historical information related to a similar event being shared with others in the past. In there is no historical information available, data from a similar cluster can be utilized by the unit determination component 202 to analyze the unit consumption.

The parameter analysis component 204 can determine a first parameter associated with withdrawal of one or more units from a first unit dispensing device, a second parameter associated with withdrawal of the one or more units from a second unit dispensing device, and subsequent parameters associated with withdrawal of the one or more units from subsequent unit dispensing devices, illustrated as unit dispensing devices 210. The first parameter, second parameter, and subsequent parameters can be based on an expected unit requirement determined based on a defined interval and data related to a first identity of a first entity associated with the computing device 208 that requested a search for one or more unit dispensing devices within a defined geographic area.

The parameter analysis component 204 can discover opportunities and an actual cost of accessing units through various unit dispensing devices. To determine the first parameter, second parameter, and subsequent parameters, the parameter analysis component 204 can compare to the actual costs associated with withdrawing units from various unit dispensing devices in order to provide the recommendations. The actual costs can include fees charged for the withdrawal of units and time expended by the entity to withdrawal units (e.g., travel time, wait time)

For example, the parameter analysis component 204 can determine one or more parameters that can include an expense to travel to the unit dispensing devices and a cost to withdrawal units. For example upon or after the recommended amount of units to withdraw is determined, the parameter analysis component 204 can review information related to the one or more unit dispensing devices 210 in a defined geographic location. The defined geographic location can be similar to a location of the computing device 208 associated with the requestor or based on a location specified by the requestor. For the one or more unit dispensing devices, the parameter analysis component 204 can determine fees charged to withdraw units, a transportation cost based on a mode (or means) of transportation, such as walking, taking a taxi, driving a car, taking the bus, and others.

According to an implementation, the interface component 206 can generate a location identification of or more of the unit dispensing devices. For example, the interface component 206 can generate a location identification of a first unit dispensing device based on a determination that the first parameter is less than a second parameter associated with respective withdrawals of one or more units from a second unit dispensing device within the defined geographic area. For example, based on the determination as to the cost associated with the withdrawal of units, the interface component 206 can generate the output 112, which can facilitate rendering of the output on the one or more computing devices 208 associated with the requestor. According to some implementations, information related to the recommended unit dispensing device, other unit dispensing devices, and a suggested unit withdrawal amount can be output at the computing device 208.

The output 112 facilitated by the interface component can be in various electronic formats including visually, such as on a display screen and/or audibly, such as through speakers or headphones. For example, the output 112 can include an electronic map-based output, wherein locations of one or more of the unit dispensing devices can be identified on the electronic map. For example, an electronic mapping based application can be utilized to provide the locations and one or more routes that can be traversed to the one or more dispensing units. According to some implementations, the electronic mapping based application can provide, within or overlaid on the electronic map, the electronic driving directions. According to some implementations, the output can include audio commands, such as driving commands or walking commands. Circuitry to generate the audio commands can be included on a motherboard or a sound card coupled to a set of external speakers or headphones.

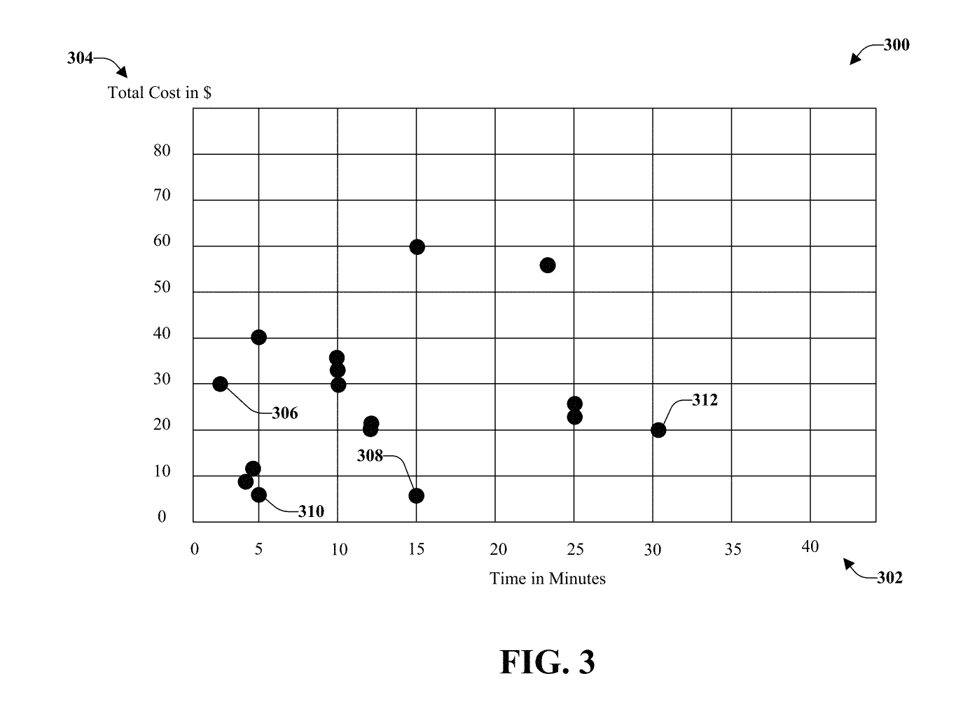

According to an implementation, the output 112 generated by the interface component 206 can include information that provides the requestor the opportunity to select one of the unit dispensing devices within a geographic area for withdrawal of the units. For example, the parameter analysis component 204 can determine an amount of time that will be spent in order to travel to the unit dispensing devices 210. It can be difficult to appraise time, or place a cost on time (e.g., time is expensive). Due the difficulty of quantifying time, the time can be expressed differently than a cost associated with withdrawal of the units. For example, the time can be expressed in a different axis than the cost and the interface component 206 can facilitate output of the comparison at one or more computing devices 208 of the requestor. For example, FIG. 3 illustrates an example, non-limiting chart 300 that displays time on a different axis than an expense associated with the withdrawal of units from one or more unit dispensing devices in accordance with one or more embodiments described herein.

As illustrated in FIG. 3, the example, non-limiting chart 300 includes a representation of time 302 on a first axis and a representation of expense 304 on a second axis. In the example of FIG. 3, the time 302 can be displayed on the horizontal axis and the expense 304 can be illustrated on the vertical axis, however, the disclosed aspects are not limited to this implementation. Further, the time 302 can be expressed as time in minutes and the expense 304 can be expressed as total cost in dollars (S), although the various aspects are not limited to this implementation and other manners of expressing the time 302 and/or the expense 304 can be utilized in accordance with the disclosed aspects.

Unit dispensing devices can be represented on the example, non-limiting chart 300 in proportion to the expenses and the time associated with the respective unit dispensing device. The parameter analysis component 204 can generate the non-limiting chart, which can provide a cluster of a solution in two dimensions that has similar cost and time metrics. The example, non-limiting chart 300 represents a suggested withdrawal amount of $250.00, according to this example.

As illustrated, the unit dispensing devices can be represented as circles. However, other manners of indicating the one or more unit dispensing devices can be utilized with the disclosed aspects. By way of example and not limitation, different circles represent a first unit dispensing device 306, a second unit dispensing device 308, a third unit dispensing device 310, and a fourth unit dispensing device 312 (other representations of unit dispensing devices are not labeled for purposes of simplicity.

In this example, the cost for withdrawing units from the first unit dispensing device 306 is around two dollars and the time is around thirty minutes. The cost for withdrawing units from the second unit dispensing device 308 is around five dollars and the time is about fifteen minutes. Further, the cost for withdrawing units from the third unit dispensing device 310 is around five dollars and the time is about five minutes. For the fourth unit dispensing device 312, the withdrawal cost is about twenty dollars and the time is around thirty-two minutes. The respective times and costs associated with the other dispensing devices can also be provided as illustrated in FIG. 3

Upon or after being presented with this information, the requestor can choose one of the unit dispensing device from which to withdraw units. For example, if the requestor would like to expend as little money as possible to withdraw the units (e.g., conserve cash), the requestor could choose the third unit dispensing device 310 (or one of the other unit dispensing devices clustered around the third unit dispensing device 310 within the example, non-limiting chart 300). However, if the requestor would rather conserve time (e.g., spend as little time as possible withdrawing the units), the requestor might chose the first unit dispensing device 306. In some cases, the requestor might choose one of the other unit dispensing devices. For example, the time might indicate a time to walk to the one or more unit dispensing devices and, if the requestor is in the mood for a walk, the requestor might choose the second unit dispensing device 308, instead of the third unit dispensing device 310.

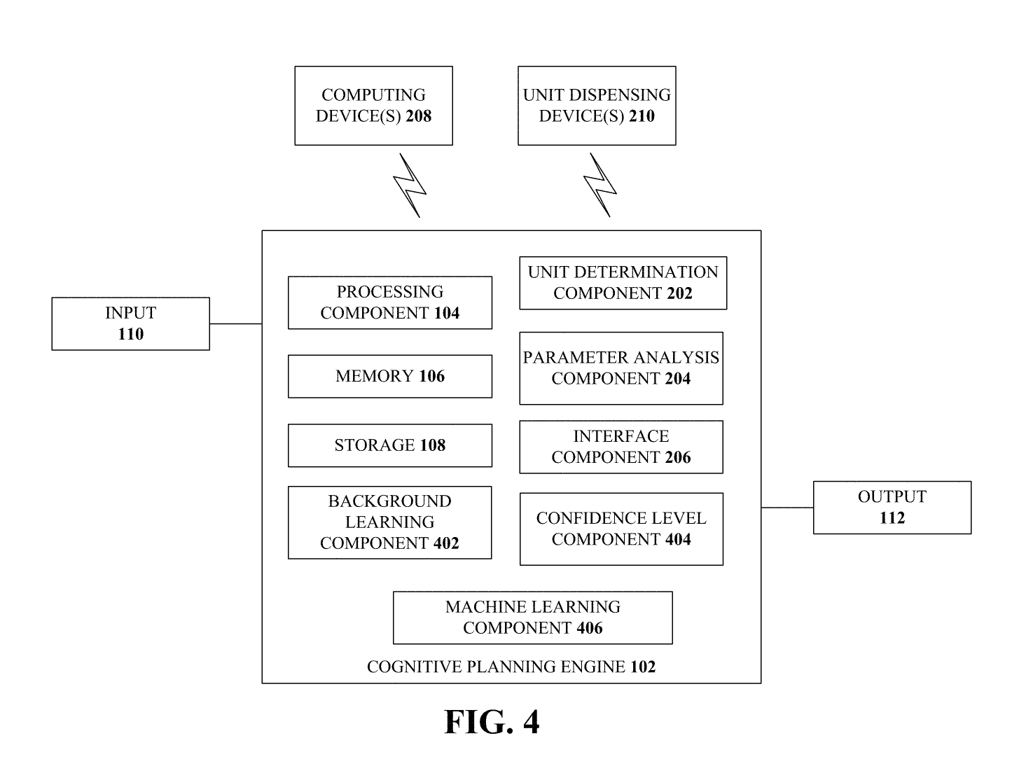

FIG. 4 illustrates a block diagram of an example, non-limiting system 400 that utilizes machine learning to enhance the cognitive planning in accordance with one or more embodiments described herein. Repetitive description of like elements employed in other embodiments described herein is omitted for sake of brevity.

The non-limiting system 400 can comprise one or more of the components and/or functionality of non-limiting system 100, and/or non-limiting system 200, and vice versa. Upon or after the unit requirement being determined by the unit determination component 202, the unit dispensing devices 210 within a defined geographic area can be evaluated by the parameter analysis component 204 and a recommended unit dispensing device can be provided. The recommendation by the parameter analysis component 204 can include one or more unit dispensing devices 210 that can conserve resources. For example, a resource can be monetary expenses, and the one or more unit dispensing devices 210 recommended can have a lower associated expense and a lower transportation cost. The transportation cost can be determined based on a mode of transportation (e.g., walk, taxi, car, bus) and preferences of the requestor (e.g., the requestor would prefer to walk today rather than drive their car). Further, an output of a route to the one or more unit dispensing devices 210 can be facilitated by the interface component 206.

Further, the non-limiting system 400 can include a background learning component 402, a confidence level component 404, and a machine learning component 406. The background learning component 402 can facilitate an adjustment to the expected unit requirement for a second defined interval based on a comparison between the expected unit requirement and a consumption of units during the first defined interval. For example, the background learning component 402 can evaluate unit spending patterns over the defined time interval. The background learning component 402 can compare the amount of units spent (or consumed) during the defined time interval to the quantity of units withdrawn for that time period. Based on this comparison, the background learning component 402 can determine whether the quantity of units consumed was less than (or more than) the quantity of units withdrawn and quantify the difference. Based on this knowledge, the background learning component 402 can update the estimate for the one or more activities based on correction factors for a current comparison and/or based on previous learning of errors.

The confidence level component 404 can evaluate the data and assign a confidence level to the corrected estimate result. For example, the confidence level can be output within a bracket of data with the recommendations. The interface component 206 can facilitate the output of the confidence level at the one or more computing devices.

Further, in an embodiment, the non-limiting system 400 can include a machine learning component 406. The machine learning component 406 can perform a set of machine learning computations associated with the inputs 110 and/or the output 112. For example, the machine learning component 406 can determine an estimated amount of units that should be withdrawn for a defined time interval, a first parameter associated with a first unit dispensing device, a second parameter associated with a second unit dispensing device, and subsequent parameters associated with subsequent unit dispensing devices located in a defined geographic area. According to another example, the machine learning component 406 can evaluate parameters of the one or more unit dispensing devices and facilitate output of a recommended unit dispensing device and/or information related to alternative unit dispensing devices that could be utilized for the withdrawal of units. Further, the machine learning component 406 can evaluate the usage of units within a defined time period and modify future recommendations related to a quantity of units to withdraw and/or a unit dispensing device from which to withdraw the units.

The machine learning component 406 can utilize machine learning systems that have been explicitly or implicitly trained to learn, determine or infer entity (or requestor) needs, unit requirements, and so on, that achieve current and/or anticipated unit capacity requirements related to a quantity of units over a defined period of time with consideration for events occurring with the defined period of time and/or the effect of other entities within the defined period of time, and so on. It is to be appreciated that machine learning systems can be implemented in one or more of the components to generate explicitly and/or implicitly trained models that provide the recommendation outputs that are determined to conserve resources of the entity (e.g., requestor). The machine learning systems can learn systems, networks, etc., identify respective unit requirements of requestors, respective preferences of requestors, and so on in order to determine or infer one or more unit dispensing devices that should be utilized by the requestor to converse resources.

According to some implementations, the interface component 206 (or respective interface components of the one or more computing devices as well as other interface components discussed herein) can provide a graphical user interface (GUI), a command line interface, a speech interface, Natural Language text interface, and the like. For example, a Graphical User Interface (GUI) can be rendered that provides a user with a region or means to load, import, select, read, and so forth, various requests and can include a region to present the results of the various requests. These regions can include known text and/or graphic regions that include dialogue boxes, static controls, drop-down-menus, list boxes, pop-up menus, as edit controls, combo boxes, radio buttons, check boxes, push buttons, graphic boxes, and so on. In addition, utilities to facilitate the information conveyance, such as vertical and/or horizontal scroll bars for navigation and toolbar buttons to determine whether a region will be viewable, can be employed. Thus, it might be inferred that the user did want the action performed.

The user can also interact with the regions to select and provide information through various devices such as a mouse, a roller ball, a keypad, a keyboard, a pen, gestures captured with a camera, a touch screen, and/or voice activation, for example. According to an aspect, a mechanism, such as a push button or the enter key on the keyboard, can be employed subsequent to entering the information in order to initiate information conveyance. However, it is to be appreciated that the disclosed aspects are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an option provided in the interface prompt or an answer to a question posed in the prompt. It is to be appreciated that the command line interface can be employed in connection with a GUI and/or Application Program Interface (API). In addition, the command line interface can be employed in connection with hardware (e.g., video cards) and/or displays (e.g., black and white, and Video Graphics Array (EGA)) with limited graphic support, and/or low bandwidth communication channels.

As discussed, the various aspects can utilize historical, behavioral, social, weather and other factors, and an electronic calendar accessible by a computing device associated with a requestor to predict a quantity of units the requestor is expected to consume over the defined period. Further, based on a previous usage of units by the requestor (e.g., historical data), an error, if any, in the predicted quantity of units can be determined and corrected for future determinations of quantity of units expected to be consumed over other defined periods. Upon or after determining the quantity of units expected to be consumed, a unit dispensing device that would conserve resources is determined. The resources conserved can include a cost of withdrawal based on fees charges at the unit dispensing devices, transportation cost based on the means of transportation (e.g., walk, taxi, car, bus, and so on) to/from the unit dispensing devices, and currency conversion rate. According to some implementations, a travel time to reach the unit dispensing device can be rendered to the requestor. For example, the time can be expressed in a different axis than the cost and the solution can provide a cluster of solutions in two dimensions that have similar cost and time metrics.

According to some implementations, at least one input can be received in response to a request to specify a time period for which the units are requested. Further inputs can include data located within a calendar or other tracking information associated with a computing device. Other inputs can include activities or locations where the requestor normally consumes units (e.g., pays by cash). Such activities can include buying coffee in the morning, doing laundry, grocery over the weekends, impulse purchases, and giving cash to a charity drive. Further, unusual or infrequent activities can be evaluated based on a purchase history (e.g., purchase of tickets for a fair, ball game, or entertainment show). Further inputs can be solicited for additional activities that it might not have been discovered by accessing the electronic calendar information, electronic purchase history, or regular electronic activity history. For the one or more activities, a determination as to the quantity of units needed can be made based, at least in part, on a previous spending history. Further, the unit requirement can be adjusted for the one or more activities based on other activities, weather, behavior, and social network.

As discussed, the various aspects disclosed consider historic data to make initial predictions on the unit withdrawal rate for any particular time period such as a day or part of the day. Unit dispensing device finder applications or programs as used by entities through respective computing devices can be used to determine which entities are showing a potential intention to withdraw units from the unit dispensing devices. In an example, the program can be an automated teller machine finder application used by banking customers. These applications or programs can be utilized to collect data based on the customer locations. Other manners of determining the entities location and/or intention to withdraw from a unit dispensing device can also be utilized (e.g., habits, patterns, and so on). The various aspects can also review historic and behavioral data to predict how many units should be withdrawn by one or more of the entities. Further, the various aspects can correct or update the prediction for one or more expected unit requirements for local events such as a concert, street fairs, or a ball game and for local weather conditions.

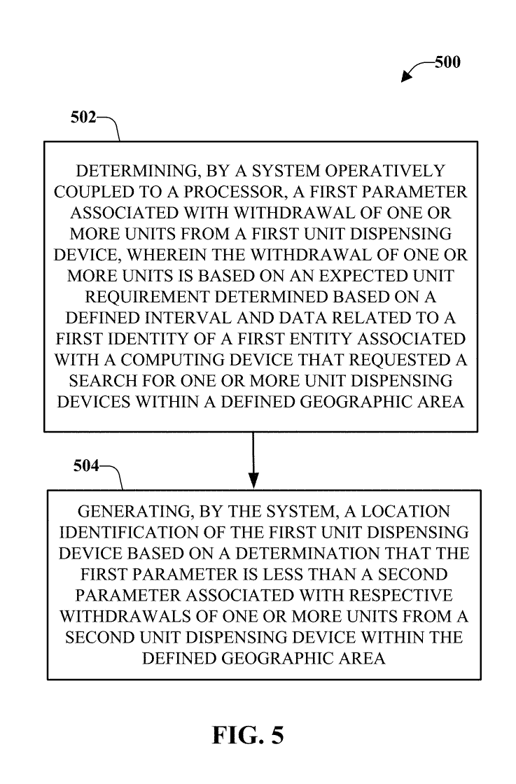

FIG. 5 illustrates a flow diagram of an example, non-limiting computer-implemented method 500 that facilitates cognitive planning in accordance with one or more embodiments described herein. At 502, a system operatively coupled to a processor, can determine a first parameter associated with withdrawal of one or more units from a first unit dispensing device (e.g., via the parameter analysis component 204). The withdrawal of one or more units can be based on an expected unit requirement determined based on a defined interval and data related to a first identity of a first entity (e.g., requestor) associated with a computing device that requested a search for one or more unit dispensing devices within a defined geographic area. In an example, the first parameter can be a cost associated with the withdrawal of one or more units from the first unit dispensing device.

According to some implementations, determining the first parameter can include determining an expense to travel to the first unit dispensing device based on a location of the first identity of the first entity associated with the computing device and a fee charged for unit withdrawal at the first unit dispensing device. Further, to this implementation, the method can include determining a time to travel to the first unit dispensing device based on an environmental condition and a mode of travel.

In accordance with some implementations, determining the first parameter can comprise determining a mode of travel to the first unit dispensing device and expenses associated with the mode of travel. Alternatively or additionally, determining the first parameter can comprise determining a first external influence on the first identity of a first entity and a second external influence on the first unit dispensing device, and wherein the first external influence and the second external influence have an impact on the first parameter.

The data related to the first identity of the first entity comprises data selected from a group consisting of historical information, electronic calendar information, electronic communication information, weather information, behavioral information, and social network information. The data can be received from one or more computing devices associated with the first identity of the first entity. Alternatively or additionally, the data can be received from other devices within an environment of the first identity of the first entity and/or the one or more unit dispensing devices.

Further, at 504, the system can generate a location identification of the first unit dispensing device based on a determination that the first parameter is less than a second parameter associated with respective withdrawals of one or more units from a second unit dispensing device within the defined geographic area (e.g., via the interface component 206). For example, it can be determined that the first unit dispensing device can conserve more resource than the second unit dispensing device and/or other unit dispensing devices within the defined geographic area.

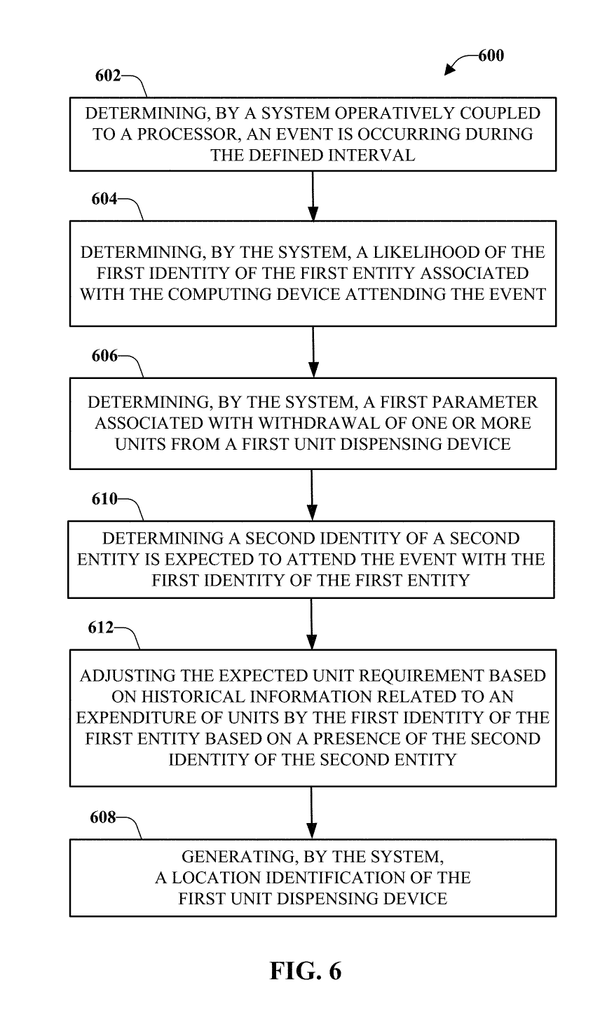

FIG. 6 illustrates a flow diagram of an example, non-limiting computer-implemented method 600 that facilitates cognitive planning in accordance with one or more embodiments described herein. At 602, a system operatively coupled to a processor, can determine an event is occurring during a defined interval. For example, the defined interval can be a defined time period during which a requestor plans to consume units withdrawn from a unit dispensing device. Further, at 604, the system can determine a likelihood of the first identity of the first entity associated with the computing device attending the event. For example, the determination can be based on communications observed at a computing device. According to some implementations, determining the likelihood comprises evaluating the computing device for communication related to the event.

Based on these determinations, at 606, the system, can determine a first parameter associated with withdrawal of units from a first unit dispensing device for consumption during the defined interval. The withdrawal of one or more units can be based on an expected unit requirement determined based on a defined interval and data related to a first identity of a first entity associated with a computing device that requested a search for one or more unit dispensing devices within a defined geographic area. At 608, a location identification of the first unit dispensing device can be generated (output at the computing device can be facilitated). For example, the identification of the first unit dispensing device can be generated based on a determination that the first parameter is less than a second parameter associated with respective withdrawals of one or more units from a second unit dispensing device within the defined geographic area.

In accordance with some implementations, prior to generating the location identification, at 610, the system can determine a second identity of a second entity is expected to attend the event with the first identity of the first entity. The determination can be made based on communications observed between the computing device of the first identity of the first entity and another computing device associated with the second identity of the second entity. Based on this determination, at 612, the system can adjust the expected unit requirement based on historical information related to an expenditure of units by the first identity of the first entity based on a presence of the second identity of the second entity. The adjusted unit requirement can be generated, at 608.

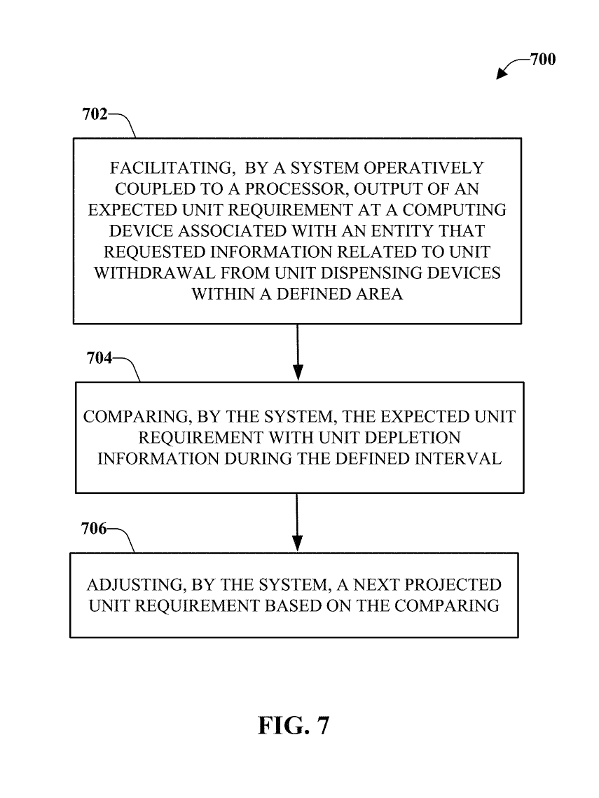

FIG. 7 illustrates a flow diagram of an example, non-limiting computer-implemented method 700 that adjusts unit withdrawal recommendations based on actual consumption of the units in accordance with one or more embodiments described herein. At 702, a system operatively coupled to a processor, can facilitate output of an expected unit requirement at a computing device associated with an entity that requested information related to unit withdrawal from unit dispensing devices within a defined area. The recommended withdrawal amount is a recommended unit withdrawal amount for the entity during a defined time interval.

At 704, the system compares the expected unit requirement with unit depletion information during the defined time interval. For example, an actual consumption rate of the entity can be observed during the defined time interval. The observation can be made based on purchases made by the entity. According to some implementations, the observation can be made based on a second unit withdrawal by the entity during the defined time period (e.g., indicates the previous unit withdrawal amount was not enough units for the defined time period). In an alternative implementation, the observation can be made based on a second unit withdrawal occurring after the defined time interval (e.g., can indicate the previous unit withdrawal amount was too much for the defined time period).

Based on the comparison, at 706, the system can adjust a next projected unit requirement. For example, the adjustment can be made based on criteria of a next time interval being similar to the compared time interval. For example, the criteria can be associated with an event or other activity in which the requestor engages. In another example, the criteria can be other entities with which the requestor will be associating with during the time period. Other criteria can include places the requestor is expected to visit and expenses the requestor is expected to incur based on the evaluated time interval.

The computer processing systems, computer-implemented methods, apparatus and/or computer program products employ hardware and/or software to solve problems that are highly technical in nature (e.g., related to determination of an expected unit requirement that is based on historical patterns and determine which unit dispensing device should be utilized in order to conserve one or more resources, combining unusual or infrequent activities into the expected unit requirement determination, modify the unit determination requirement based one or more of external influences, mood, and social behavior, evaluating actual consumption and modifying another expected unit requirements based on the actual consumption), that are not abstract and that cannot be performed as a set of mental acts by a human. For example, a human, or even thousands of humans, cannot efficiently, accurately and effectively manually analyze the voluminous amounts of incongruent inputs that should be analyzed and the disparate inputs for the parameters associated with the one or more unit dispensing devices in order to conserve resources as provided herein. Thus, the one or more embodiments of the subject computer processing systems, methods, apparatuses and/or computer program products can enable the automated determination of a quantity of units to be withdrawn and detection of the unit dispensing device from which to withdraw the units.

For simplicity of explanation, the computer-implemented methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts can be required to implement the computer-implemented methodologies in accordance with the disclosed subject matter. In addition, those skilled in the art will understand and appreciate that the computer-implemented methodologies could alternatively be represented as a series of interrelated states via a state diagram or events. Additionally, it should be further appreciated that the computer-implemented methodologies disclosed hereinafter and throughout this specification are capable of being stored on an article of manufacture to facilitate transporting and transferring such computer-implemented methodologies to computers. The term article of manufacture, as used herein, is intended to encompass a computer program accessible from any computer-readable device or storage media.

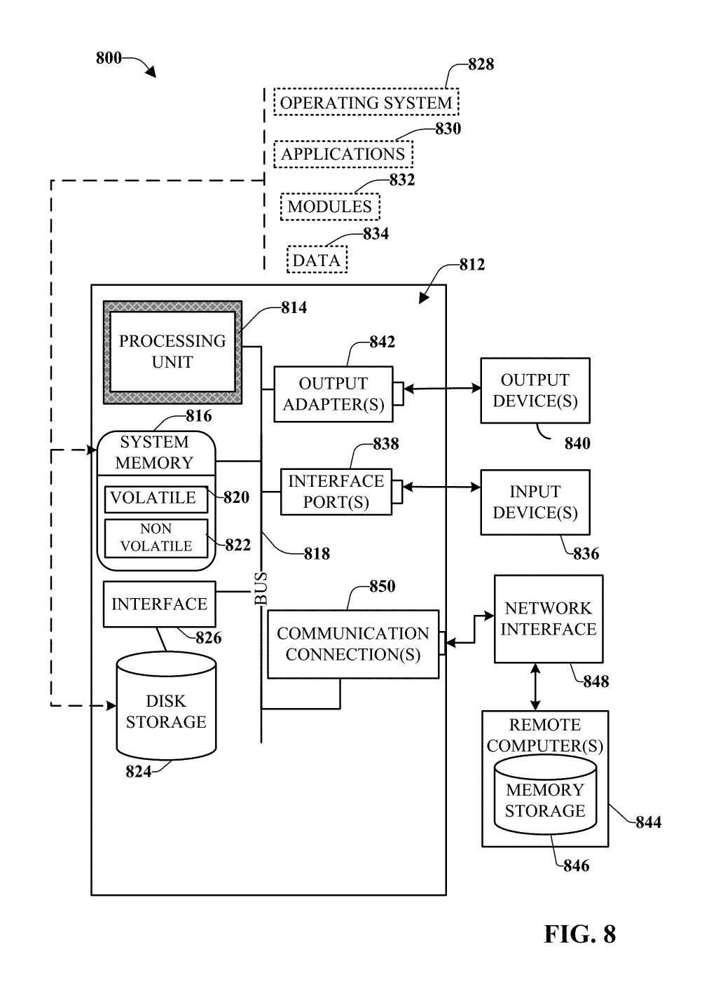

In order to provide a context for the various aspects of the disclosed subject matter, FIG. 8 as well as the following discussion are intended to provide a general description of a suitable environment in which the various aspects of the disclosed subject matter can be implemented. FIG. 8 illustrates a block diagram of an example, non-limiting operating environment in which one or more embodiments described herein can be facilitated. Repetitive description of like elements employed in other embodiments described herein is omitted for sake of brevity. With reference to FIG. 8, a suitable operating environment 800 for implementing various aspects of this disclosure can also include a computer 812. The computer 812 can also include a processing unit 814, a system memory 816, and a system bus 818. The system bus 818 couples system components including, but not limited to, the system memory 816 to the processing unit 814. The processing unit 814 can be any of various available processors. Dual microprocessors and other multiprocessor architectures also can be employed as the processing unit 814. The system bus 818 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Firewire (IEEE 1394), and Small Computer Systems Interface (SCSI). The system memory 816 can also include volatile memory 820 and nonvolatile memory 822. The basic input/output system (BIOS), containing the basic routines to transfer information between elements within the computer 812, such as during start-up, is stored in nonvolatile memory 822. By way of illustration, and not limitation, nonvolatile memory 822 can include read only memory (ROM), programmable ROM (PROM), electrically programmable ROM (EPROM), electrically erasable programmable ROM (EEPROM), flash memory, or nonvolatile random access memory (RAM) (e.g., ferroelectric RAM (FeRAM). Volatile memory 820 can also include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM.

Computer 812 can also include removable/non-removable, volatile/nonvolatile computer storage media. FIG. 8 illustrates, for example, a disk storage 824. Disk storage 824 can also include, but is not limited to, devices like a magnetic disk drive, floppy disk drive, tape drive, Jaz drive, Zip drive, LS-100 drive, flash memory card, or memory stick. The disk storage 824 also can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 824 to the system bus 818, a removable or non-removable interface is typically used, such as interface 826. FIG. 8 also depicts software that acts as an intermediary between users and the basic computer resources described in the suitable operating environment 800. Such software can also include, for example, an operating system 828. Operating system 828, which can be stored on disk storage 824, acts to control and allocate resources of the computer 812. System applications 830 take advantage of the management of resources by operating system 828 through program modules 832 and program data 834, e.g., stored either in system memory 816 or on disk storage 824. It is to be appreciated that this disclosure can be implemented with various operating systems or combinations of operating systems. A user enters commands or information into the computer 812 through input device(s) 836. Input devices 836 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 814 through the system bus 818 via interface port(s) 838. Interface port(s) 838 include, for example, a serial port, a parallel port, a game port, and a universal serial bus (USB). Output device(s) 840 use some of the same type of ports as input device(s) 836. Thus, for example, a USB port can be used to provide input to computer 812, and to output information from computer 812 to an output device 840. Output adapter 842 is provided to illustrate that there are some output devices 840 like monitors, speakers, and printers, among other output devices 840, which require special adapters. The output adapters 842 include, by way of illustration and not limitation, video and sound cards that provide a method of connection between the output device 840 and the system bus 818. It should be noted that other devices and/or systems of devices provide both input and output capabilities such as remote computer(s) 844.

Computer 812 can operate in a networked environment using logical connections to one or more remote computers, such as remote computer(s) 844. The remote computer(s) 844 can be a computer, a server, a router, a network PC, a workstation, a microprocessor based appliance, a peer device or other common network node and the like, and typically can also include many or all of the elements described relative to computer 812. For purposes of brevity, only a memory storage device 846 is illustrated with remote computer(s) 844. Remote computer(s) 844 is logically connected to computer 812 through a network interface 848 and then physically connected via communication connection 850. Network interface 848 encompasses wire and/or wireless communication networks such as local-area networks (LAN), wide-area networks (WAN), cellular networks, etc. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL). Communication connection(s) 850 refers to the hardware/software employed to connect the network interface 848 to the system bus 818. While communication connection 850 is shown for illustrative clarity inside computer 812, it can also be external to computer 812. The hardware/software for connection to the network interface 848 can also include, for exemplary purposes only, internal and external technologies such as, modems including regular telephone grade modems, cable modems and DSL modems, ISDN adapters, and Ethernet cards.

The present invention can be a system, a method, an apparatus and/or a computer program product at any possible technical detail level of integration. The computer program product can include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of the present invention can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create method for implementing the functions/acts specified in the flowchart and/or block diagram block or blocks. These computer readable program instructions can also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer and/or computers, those skilled in the art will recognize that this disclosure also can or can be implemented in combination with other program modules. Generally, program modules include routines, programs, components, data structures, etc. that perform particular tasks and/or implement particular abstract data types. Moreover, those skilled in the art will appreciate that the inventive computer-implemented methods can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments where tasks are performed by remote processing devices that are linked through a communications network. However, some, if not all aspects of this disclosure can be practiced on stand-alone computers. In a distributed computing environment, program modules can be located in both local and remote memory storage devices.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models. The characteristics are as follows: on-demand self-service: a cloud consumer can unilaterally provision computing capabilities, such as server time and network storage, as needed automatically without requiring human interaction with the service's provider. Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a high level of abstraction (e.g., country, state, or data center). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time. Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows: Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings. Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations. Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of selected networking components (e.g., host firewalls).

Deployment Models are as follows: Private cloud: the cloud infrastructure is operated solely for an organization. It can be managed by the organization or a third party and can exist on-premises or off-premises. Community cloud: the cloud infrastructure is shared by several organizations and supports a specific community that has shared concerns (e.g., mission, security requirements, policy, and compliance considerations). It can be managed by the organizations or a third party and can exist on-premises or off-premises. Public cloud: the cloud infrastructure is made available to the general public or a large industry group and is owned by an organization selling cloud services. Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

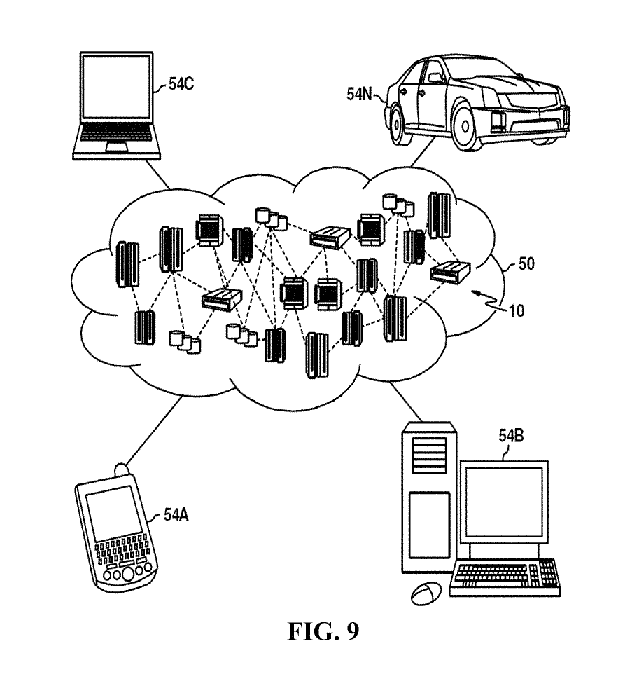

Referring now to FIG. 9, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N can communicate. Nodes 10 can communicate with one another. They can be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

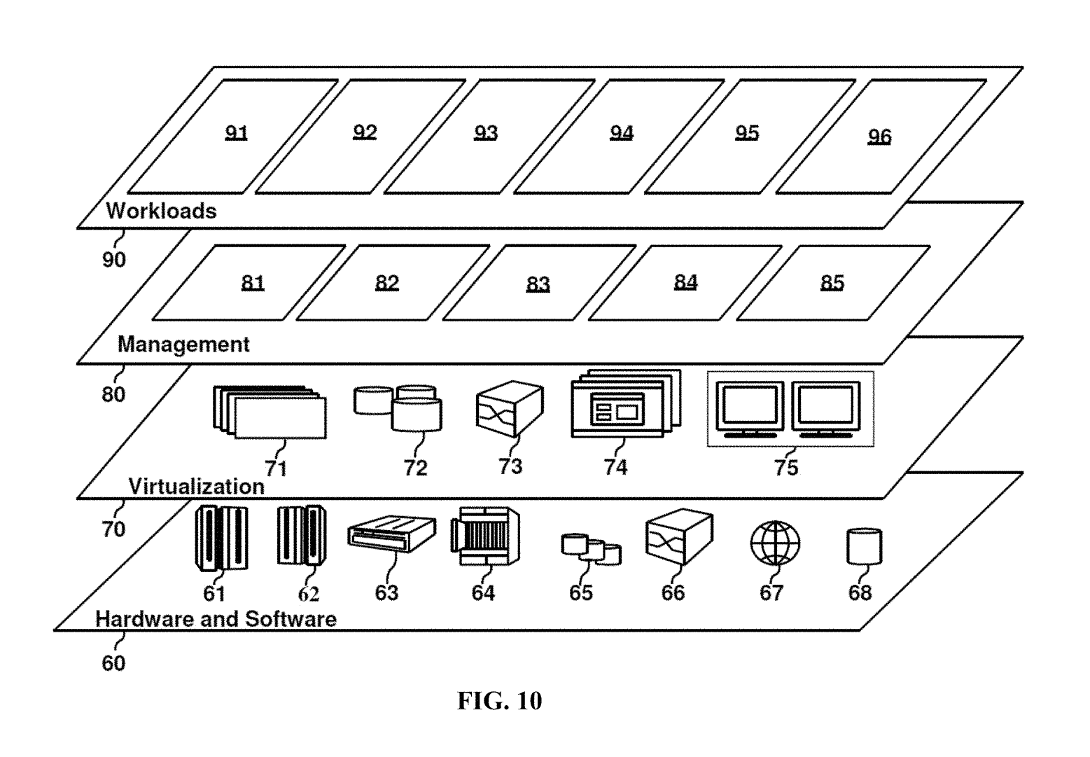

Referring now to FIG. 10, a set of functional abstraction layers provided by cloud computing environment 50 (FIG. 9) is shown. It should be understood in advance that the components, layers, and functions shown in FIG. 10 are intended to be illustrative only and embodiments of the invention are not limited thereto. As depicted, the following layers and corresponding functions are provided: Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75.

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, the procurement of, cloud computing resources for which a future requirement is anticipated in accordance with an SLA.

Workloads layer 90 provides examples of functionality for which the cloud computing environment can be utilized. Examples of workloads and functions which can be provided from this layer include: mapping and navigation 91; software development and lifecycle management 92; virtual classroom education delivery 93; data analytics processing 94; transaction processing 95; and estimating node processing capacity values for order fulfillment 96.

As used in this application, the terms “component,” “system,” “platform,” “interface,” and the like, can refer to and/or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other method to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory and/or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but one of ordinary skill in the art can recognize that many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim. The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
determining, by a system operatively coupled to a processor, a first parameter associated with withdrawal of one or more units from a first unit dispensing device, wherein the withdrawal of one or more units is based on an expected unit requirement determined based on a defined interval and data related to a first identity of a first entity associated with a computing device that requested a search for one or more unit dispensing devices within a defined geographic area; and
generating, by the system, a location identification of the first unit dispensing device based on a determination that the first parameter is less than a second parameter associated with respective withdrawals of one or more units from a second unit dispensing device within the defined geographic area.

2. The computer-implemented method of claim 1, wherein the determining the expected unit requirement comprises:
determining, by the system, that an event is occurring during the defined interval; and
determining, by the system, a likelihood of the first identity of the first entity associated with the computing device attending the event.

3. The computer-implemented method of claim 2, wherein the determining the likelihood comprises evaluating the computing device for electronic communications related to the event.

4. The computer-implemented method of claim 2, wherein the determining the expected unit requirement comprises:
determining a second identity of a second entity is expected to attend the event with the first identity of the first entity; and
adjusting the expected unit requirement based on historical information related to an expenditure of units by the first identity of the first entity based on a presence of the second identity of the second entity.

5. The computer-implemented method of claim 1, wherein the determining the first parameter comprises determining an expense to travel to the first unit dispensing device based on a location of the first identity of the first entity associated with the computing device and a fee charged for unit withdrawal at the first unit dispensing device.

6. The computer-implemented method of claim 5, wherein the determining the expense to travel comprises determining a time to travel to the first unit dispensing device based on an environmental condition and a mode of travel.

7. The computer-implemented method of claim 1, wherein the data related to the first identity of the first entity comprises data selected from a group consisting of historical information, calendar information, communication information, weather information, behavioral information, and social network information.

8. The computer-implemented method of claim 1, further comprising:
comparing, by the system, the expected unit requirement with unit depletion information during the defined interval; and
adjusting, by the system, a next projected unit requirement based on the comparing.

9. The computer-implemented method of claim 1, wherein the first parameter is a cost associated with the withdrawal of one or more units from the first unit dispensing device.

10. The computer-implemented method of claim 1, wherein the determining the first parameter comprises determining a mode of travel to the first unit dispensing device and expenses associated with the mode of travel.

11. The computer-implemented method of claim 1, wherein the determining the first parameter comprises determining a first external influence on the first identity of the first entity and a second external influence on the first unit dispensing device, and wherein the first external influence and the second external influence have an impact on the first parameter.

12. A system, comprising:
a memory that stores computer executable components; and
a processor that executes the computer executable components stored in the memory, wherein the computer executable components comprise:
a parameter analysis component that determines a first parameter associated with a first withdrawal of one or more units from a first unit dispensing device based on an expected unit requirement over a first defined interval and data related to a first entity; and
an interface component that facilitates a first output of a location identification of the first unit dispensing device at a computing device associated with the first entity based on the first parameter being less than a second parameter associated with a second withdrawal of one or more units from a second unit dispensing device based on the expected unit requirement over the first defined interval and the data related to the first entity.

13. The system of claim 12, wherein the computer executable components further comprise a unit determination component that determines the expected unit requirement based on patterns of unit consumption based on historical data related to the first entity for a similar defined interval.

14. The system of claim 12, wherein the computer executable components further comprise a background learning component that facilitates an adjustment to the expected unit requirement for a second defined interval based on a comparison between the expected unit requirement and a consumption of units during the first defined interval.

15. The system of claim 14, wherein the computer executable components further comprise a confidence level component that facilitates a second output of a confidence level associated with the adjustment to the expected unit requirement.

16. The system of claim 12, wherein the data related to the first entity comprises data selected from a group consisting of historical information, calendar information, communication information, weather information, behavioral information, and social network information.

17. A computer program product for facilitating cognitive planning to conserve resources, the computer program product comprising a computer readable storage medium having program instructions embodied therewith, the program instructions executable by a processing component to cause the processing component to:
determine, by the processing component, a first parameter associated with a first withdrawal of units from a first unit dispensing device is less than a second parameter associated with a second withdrawal of units from a second unit dispensing device; and
facilitate, by the processing component, an output of a location identification of the first unit dispensing device at a computing device associated with a first identity of a first entity that requested a search for one or more unit dispensing devices within a defined geographic area, wherein the first withdrawal of units and the second withdrawal of units comprise a quantity of units based on an expected unit requirement for the first entity during a defined interval.

18. The computer program product of claim 17, wherein the program instructions further cause the processing component to:
determine, by the processing component, that an event is scheduled during the defined interval; and
determine, by the processing component, a likelihood of the first entity attending the event based on an evaluation of the computing device for electronic communications related to the event.

19. The computer program product of claim 18, wherein the program instructions further cause the processing component to:
determine, by the processing component, a second entity is expected to attend the event with the first entity; and
adjusting, by the processing component, the expected unit requirement based on historical information related to an expenditure of units by the first entity based on a presence of the second entity during the event.

20. The computer program product of claim 17, wherein the program instructions further cause the processing component to:
adjust, by the processing component, a next projected unit requirement based on a comparison between the expected unit requirement with a unit consumption during the defined interval.
